(19) United States
(12) Patent Application Publication
(10) Pub. No.: US 2025/0048305 A1
(43) Pub. Date: Feb. 6, 2025

(54) COMMUNICATING IDENTITY MESSAGES BETWEEN NETWORK DEVICES

(71) Applicant: Lenovo (Singapore) Pte. Ltd., New Tech Park (SG)

(72) Inventors: Sheeba Backia Mary Baskaran, Friedrichsdorf (DE); Andreas Kunz, Ladenburg (DE)

(21) Appl. No.: 18/717,352

(22) PCT Filed: Dec. 6, 2022
(86) PCT No.: PCT/IB2022/061852

§ 371 Date: Jun. 6, 2024

Related U.S. Application Data
(60) Provisional application No. 63/286,883, filed on Dec. 7, 2021.

(51) Int. Cl. H04W 60/04; H04W 48/16; H04W 48/18; H04W 60/06

(52) U.S. Cl. CPC H04W 60/04; H04W 48/16; H04W 48/18; H04W 60/06

(57) ABSTRACT

Apparatuses, methods, and systems are disclosed for communicating identity messages between network devices. One method includes receiving, at a first network device, network repository function (“NRF”) level information from a second network device. The method includes transmitting an identity request message to a third network device. The identity request message includes target access and mobility management function (“AMF”) information, selection information, a subscription permanent identifier (“SUPI”), and/or an AMF reallocation indication. The method includes receiving an identity response message from the third network device. The identity response message includes a global unique temporary identifier (“GUTI”) and/or the SUPI. The method includes transmitting a registration accept message to a user equipment (“UE”). The registration accept message includes the GUTI and/or a reroute indication. The method includes receiving a registration complete message from the UE.

### CROSS-REFERENCE TO RELATED APPLICATIONS

This application claims priority to U.S. Patent Application Ser. No. 63/286,883 entitled “APPARATUSES, METHODS, AND SYSTEMS FOR SELECTING AND USING THE RIGHT NF LEVEL TO HANDLE AMF REALLOCATION” and filed on Dec. 7, 2021 for Sheeba Backia Mary Baskaran et al., which is incorporated herein by reference in its entirety.

### FIELD

The subject matter disclosed herein relates generally to wireless communications and more particularly relates to communicating identity messages between network devices.

### BACKGROUND

In certain wireless communications networks, a network repository function (“NRF”) may belong to one of many network function (“NF”) levels.

### BRIEF SUMMARY

Methods for communicating identity messages between network devices are disclosed. Apparatuses and systems also perform the functions of the methods. One embodiment of a method includes receiving, at a first network device, NRF level information from a second network device. In some embodiments, the method includes transmitting an identity request message to a third network device, wherein the identity request message comprises target access and mobility management function (“AMF”) information, selection information, a subscription permanent identifier (“SUPI”), an AMF reallocation indication, or a combination thereof. In certain embodiments, the method includes receiving an identity response message from the third network device, wherein the identity response message includes a global unique temporary identifier (“GUTI”), the SUPI, or a combination thereof. In various embodiments, the method includes transmitting a registration accept message to a user equipment (“UE”), wherein the registration accept message includes the GUTI, a reroute indication, or a combination thereof. In some embodiments, the method includes receiving a registration complete message from the UE.

One apparatus for communicating identity messages between network devices includes a processor. In some embodiments, the apparatus includes a memory coupled to the processor, the processor configured to cause the apparatus to: receive NRF level information from a second network device: transmit an identity request message to a third network device, wherein the identity request message comprises target AMF information, selection information, a SUPI, an AMF reallocation indication, or a combination thereof: receive an identity response message from the third network device, wherein the identity response message includes a GUTI, the SUPI, or a combination thereof: transmit a registration accept message to a UE, wherein the registration accept message comprises the GUTI, a reroute indication, or a combination thereof; and receive a registration complete message from the UE.

Another embodiment of a method for communicating identity messages between network devices includes receiving, at a third network device, an identity request message from a first network device, wherein the identity request message comprises target AMF information, selection information, a SUPI, an AMF reallocation indication, or a combination thereof. In some embodiments, the method includes transmitting the identity request message to a fourth network device. In certain embodiments, the method includes receiving an identity response message from the fourth network device, wherein the identity response message includes a GUTI, the SUPI, or a combination thereof. In various embodiments, the method includes transmitting the identity response message to the first network device.

Another apparatus for communicating identity messages between network devices includes a processor. In some embodiments, the apparatus includes a memory coupled to the processor, the processor configured to cause the apparatus to: receive an identity request message from a first network device, wherein the identity request message includes target AMF information, selection information, a SUPI, an AMF reallocation indication, or a combination thereof: transmit the identity request message to a fourth network device: receive an identity response message from the fourth network device, wherein the identity response message includes a GUTI, the SUPI, or a combination thereof; and transmit the identity response message to the first network device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating identity messages between network devices;

FIG. 2 is a schematic block diagram illustrating one embodiment of an apparatus that may be used for communicating identity messages between network devices:

FIG. 3 is a schematic block diagram illustrating one embodiment of an apparatus that may be used for communicating identity messages between network devices:

FIG. 4 is a schematic block diagram illustrating one embodiment of a system including communications for registration with an AMF re-allocation procedure:

FIG. 5 is a schematic block diagram illustrating one embodiment of a system including communications for AMF re-allocation:

FIG. 6 is a schematic block diagram illustrating one embodiment of a system including communications for registration with indirect AMF reallocation with NRF supporting communications between an initial and a reallocated target AMF:

FIG. 7 is a schematic block diagram illustrating one embodiment of a system including communications for registration with indirect AMF reallocation involving co-ordination among NFs with different NF levels:

FIG. 8 is a schematic block diagram illustrating one embodiment of a system including communications for registration with indirect AMF reallocation with a network slice selection function (“NSSF”) and/or any core network function supporting communications between an initial and a reallocated target AMF:

FIG. 9 is a flow chart diagram illustrating one embodiment of a method for communicating identity messages between network devices; and

FIG. 10 is a flow chart diagram illustrating another embodiment of a method for communicating identity messages between network devices.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

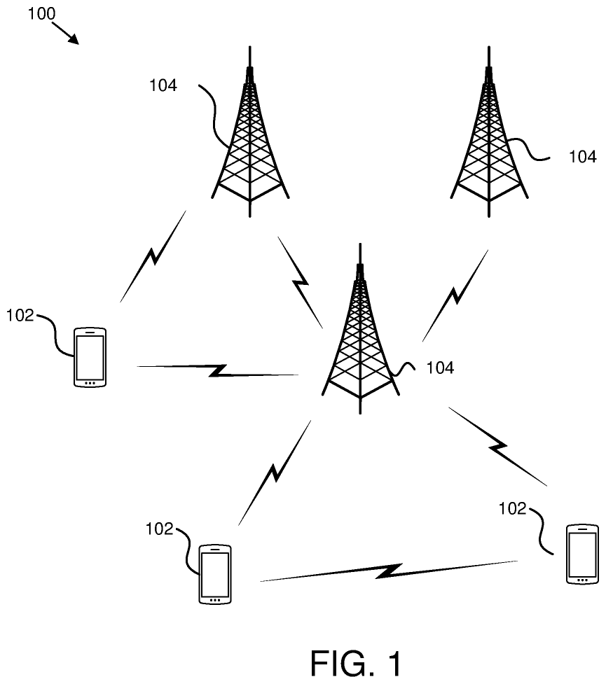

FIG. 1 depicts an embodiment of a wireless communication system 100 for communicating identity messages between network devices. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a fifth generation (“5G”) node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-third generation partnership project (“3GPP”) gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in 3GPP, wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive NRF level information from a second network device. In some embodiments, the network unit 104 may transmit an identity request message to a third network device, wherein the identity request message comprises target AMF information, selection information, a SUPI, an AMF reallocation indication, or a combination thereof. In certain embodiments, the network unit 104 may receive an identity response message from the third network device, wherein the identity response message includes a GUTI, the SUPI, or a combination thereof. In various embodiments, the network unit 104 may transmit a registration accept message to a UE, wherein the registration accept message includes the GUTI, a reroute indication, or a combination thereof. In some embodiments, the network unit 104 may receive a registration complete message from the UE. Accordingly, the network unit 104 may be used for communicating identity messages between network devices.

In certain embodiments, a network unit 104 may receive an identity request message from a first network device, wherein the identity request message comprises target AMF information, selection information, a SUPI, an AMF reallocation indication, or a combination thereof. In some embodiments, the network unit 104 may transmit the identity request message to a fourth network device. In certain embodiments, the network unit 104 may receive an identity response message from the fourth network device, wherein the identity response message includes a GUTI, the SUPI, or a combination thereof. In various embodiments, the network unit 104 may transmit the identity response message to the first network device. Accordingly, the network unit 104 may be used for communicating identity messages between network devices.

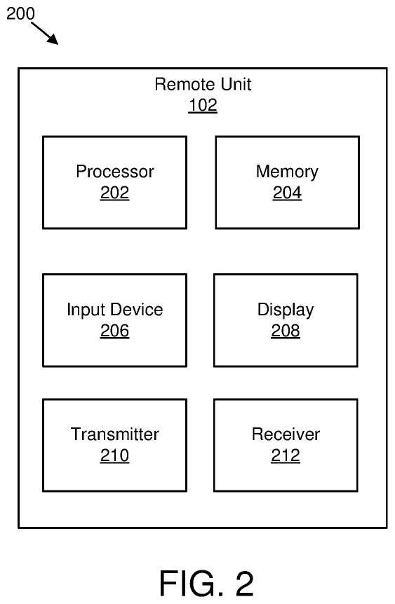

FIG. 2 depicts one embodiment of an apparatus 200 that may be used for communicating identity messages between network devices. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

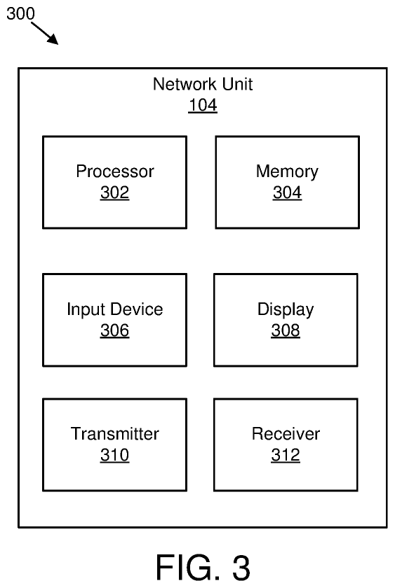

FIG. 3 depicts one embodiment of an apparatus 300 that may be used for communicating identity messages between network devices. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the processor 302 is configured to cause the apparatus 300 to: receive NRF level information from a second network device: transmit an identity request message to a third network device, wherein the identity request message comprises target AMF information, selection information, a SUPI, an AMF reallocation indication, or a combination thereof: receive an identity response message from the third network device, wherein the identity response message includes a GUTI, the SUPI, or a combination thereof: transmit a registration accept message to a UE, wherein the registration accept message comprises the GUTI, a reroute indication, or a combination thereof; and receive a registration complete message from the UE.

In some embodiments, the processor 302 is configured to cause the apparatus 300 to: receive an identity request message from a first network device, wherein the identity request message includes target AMF information, selection information, a SUPI, an AMF reallocation indication, or a combination thereof: transmit the identity request message to a fourth network device: receive an identity response message from the fourth network device, wherein the identity response message includes a GUTI, the SUPI, or a combination thereof; and transmit the identity response message to the first network device.

It should be noted that one or more embodiments described herein may be combined into a single embodiment.

In certain embodiments, during registration, if an initial AMF cannot serve a UE, the initial AMF may determine to perform AMF reallocation and indirect rerouting due to network slice isolation requirements. If the initial AMF establishes non-access stratum (“NAS”) security with the UE, then after AMF reallocation, the UE may not accept any unprotected NAS message from the reallocated target AMF leading to registration failure. Based on operator's implementation, a NRF may belong to any NF level such as a public land mobile network (“PLMN”) level, a shared-slice level, or slice-specific level respectively. The initial AMF, upon receiving a registration request, determines whether it cannot serve the UE, the initial AMF can request the NRF to get a target AMF identity (e.g., 5G globally unique temporary identifier (“GUTI”) (“5G-GUTI”)) to enforce UE deregistration and to enable the UE to re-register to the reallocated target AMF directly using the target AMF's 5G-GUTI.

If the NRF requested by the initial AMF belongs to a slice-specific level, then the NRF may not contact and/or communicate with the network slice isolated target AMF leading to target AMF identification request failure which may impact registration with AMF reallocation.

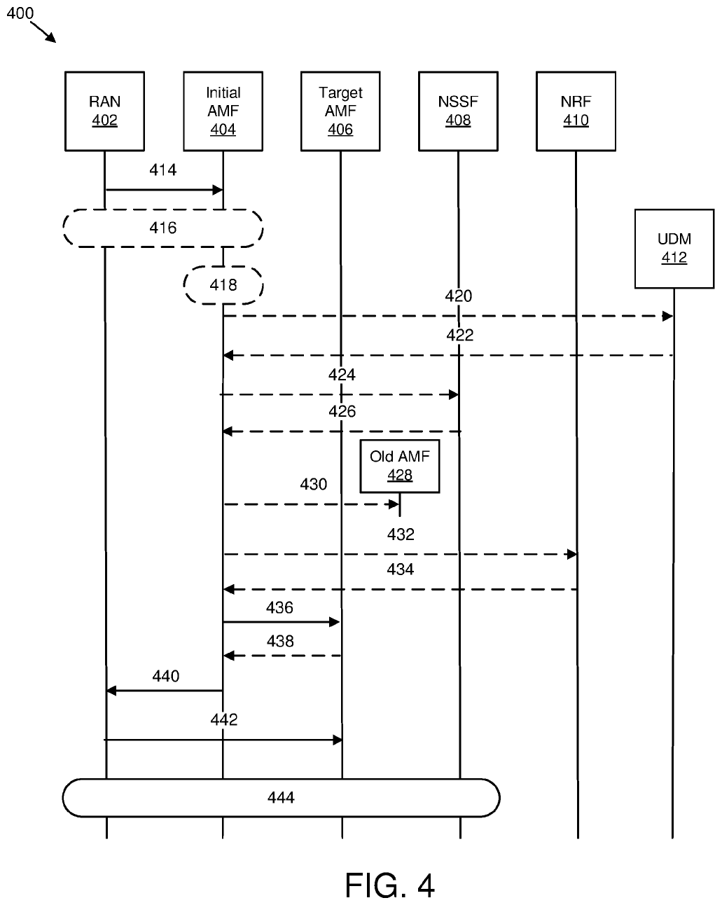

In some embodiments, registration with AMF re-allocation may be made as shown in FIG. 4. In FIG. 4, there are two AMF reallocation and reroute cases that include direct rerouting and indirect rerouting via RAN. If an AMF receives a registration request, the AMF may need to reroute the registration request to another AMF (e.g., when the initial AMF is not the appropriate AMF to serve the UE). If a security association has been established between the UE and initial AMF, to avoid a registration failure, the initial AMF may forward the NAS message to the target AMF such as by direct rerouting.

It should be noted that the NRFs returned by the NSSF, if any, belong to any level of NRF according to a deployment decision of an operator. Moreover, the security context in the initial AMF is not transferred to the target AMF if the initial AMF forwards the NAS message to the target AMF via the RAN. In this case, the UE rejects the NAS message sent from the target AMF as the security context in the UE and target AMF are not synchronized (e.g., this can lead to a registration failure issue. Network slice isolation may not be completely maintained if the AMF reallocation is executed.

If the initial AMF is not part of the target AMF set, and is not able to get a list of candidate AMFs by querying the NRF with the target AMF set (e.g., the NRF locally pre-configured on AMF does not provide the requested information, the query to the appropriate NRF provided by the NSSF is not successful, the initial AMF has knowledge that the initial AMF is not authorized as serving AMF, and so forth), then the initial AMF may forward the NAS message to the target AMF via the RAN unless the security association has been established between the UE and initial AMF. The allowed network slice selection assistance information (“NSSAI”) and the AMF set may be included to enable the RAN to select the target AMF.

Further, registration failure may result in a reroute via RAN as illustrated.

FIG. 4 is a schematic block diagram illustrating one embodiment of a system 400 including communications for registration with an AMF re-allocation procedure. The system 400 includes a RAN 402, an initial AMF 404, a target AMF 406, an NSSF 408, an NRF 410, and a UDM 412. Each of the communications in the system 400 may include one or more messages.

In a first communication 414, an initial UE message is transmitted.

In a second communication 416, optional steps may be performed via communications between the RAN 402 and the initial AMF 404.

The initial AMF 404 may perform 418 UDM selection.

In a third communication 420, a Nudm_SDM_Get message may be transmitted (e.g., including slice selection subscription data).

In a fourth communication 422, a Nudm_SDM_Get response message may be transmitted.

In a fifth communication 424, a Nnssf_NSSelection_Get message may be transmitted.

In a sixth communication 426, a Nnssf_NSSelection_Get response message may be transmitted.

An old AMF 428, in a seventh communication 430, may receive an Namf_Communication_RegistrationStatusUpdate message.

In an eighth communication 432, an Nnrf_NFDiscovery_Request message may be transmitted.

In a ninth communication 434, an Nnrf_NFDiscovery_Request response message may be transmitted.

In one option (e.g., option A), in a tenth communication 436, an Namf_Communication_NIMessageNotify message may be sent. In an eleventh communication 438, an optional response may be sent.

In another option (e.g., option B), in a twelfth communication 440, a reroute NAS message may be transmitted. In a thirteenth communication 442, a new initial UE message may be transmitted.

In a fourteenth communication 444, additional communication steps may be performed.

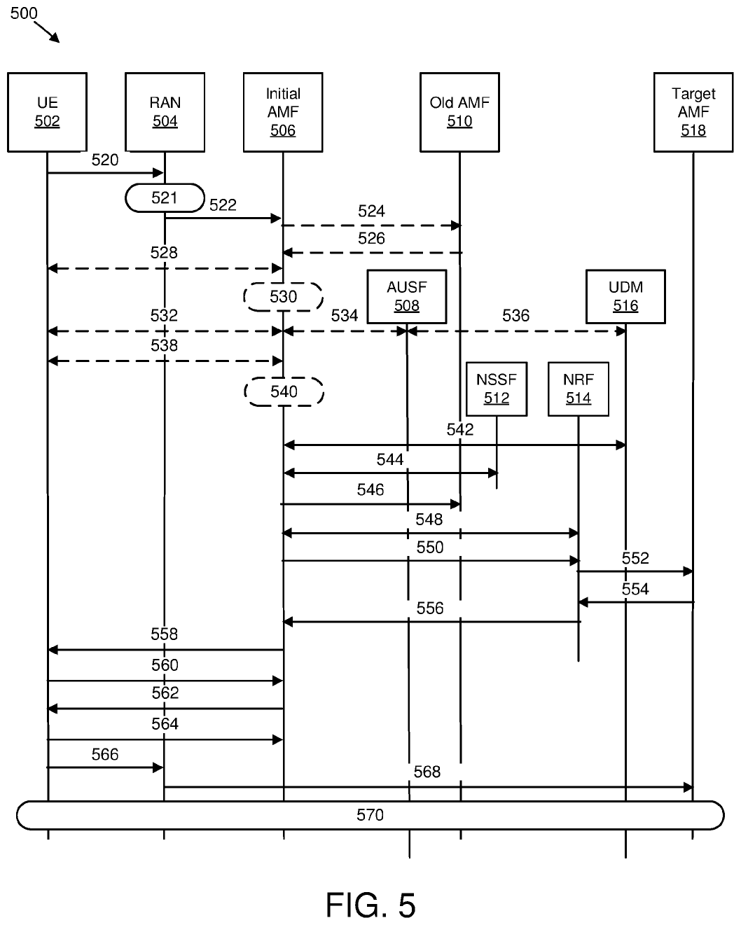

FIG. 5 is a schematic block diagram illustrating one embodiment of a system 500 including communications for AMF re-allocation. The system 500 includes a UE 502, a RAN 504, an initial AMF 506, an AUSF 508, an old AMF 510, an NSSF 512, an NRF 514, a UDM 516, and a target AMF 518. Each of the communications in the system 500 may include one or more messages.

In a first communication 520, a registration request message is transmitted.

The RAN 504 performs 521 AMF selection.

In a second communication 522, the registration request message is further transmitted.

In a third communication 524, an Namf_Communication_UEContextTransfer message is transmitted.

In a fourth communication 526, an Namf_Communication_UEContextTransfer response message is transmitted.

In a fifth communication 528, an identity request and/or an identity response message are communicated.

The initial AMF 506 may perform 530 AUSF selection.

In a sixth communication 532, a seventh communication 534, and an eighth communication 536, authentication and/or security messages may be communicated.

In a ninth communication 538, security mode command and/or complete messages may be communicated.

The initial AMF 506 may perform 540 UDM selection.

In a tenth communication 542, Nudm_SDM_Get and/or response messages may be communicated.

In an eleventh communication 544, Nnssf_NSelection_Get and/or response messages may be communicated.

In a twelfth communication 546, an Namf_Communication_Registration status update message may be transmitted.

In a thirteenth communication 548, an Nnrf_NFDiscovery_Request and/or response message may be communicated. Such communications may include a target AMF list.

In various embodiments, if the initial AMF 506 determines to perform indirect AMF reallocation, additional communications that follow may occur.

In a fourteenth communication 550, the initial AMF 506 selects a target AMF and sends a Selected_AMF_identity_request message with the target AMF ID to the NRF 514.

In a fifteenth communication 552, the NRF 514 sends an identity request to the target AMF 518 to get a 5G-GUTI.

In a sixteenth communication 554, the target AMF 518 sends an identity response to the NRF 514 with a 5G-GUTI.

In a seventeenth communication 556, the NRF 514 forwards the 5G-GUTI to the initial AMF 506 in a Selected_AMF_identity_response message.

In an eighteenth communication 558, the initial AMF 506 sends a registration accept message to the UE 502. The message includes a 5G-GUTI that is used for the target AMF 518. The initial AMF 506 gets the list of candidate AMFs from the NRF 514. The NRF 514 replies with the list of potential target AMFs. The NRF 514 may also provide the details of the services offered by the candidate AMFs along with the notification end-point for each type of notification service that the selected AMF had registered with the NRF, if available. As an alternative, it provides a list of potential target AMFs and their capabilities, and optionally, additional selection rules. Based on the information about registered NFs and required capabilities, a target AMF is selected by the initial AMF. Afterwards, the initial AMF 506 generates the globally unique AMF ID (“GUAMI”) and 5G temporary mobile subscriber identity (“TMSI”) (“5G-TMSI”) to construct the 5G-GUTI.

In a nineteenth communication 560, the UE 502 transmits a response including a registration complete message to the initial AMF 506.

In a twentieth communication 562, the initial AMF 506 sends a de-registration request message to the UE 502 with a registration indication to start a new registration procedure.

In a twenty-first communication 564, the UE 502 sends a de-registration accept message to the initial AMF 506. Afterwards, the UE 502 and the initial AMF 506 release an NI NAS signalling connection.

In a twenty-second communication 566, the UE 502 sends an initial UE message to the RAN 504 using the new 5G-GUTI received. After release of the NI NAS signalling connection between the initial AMF 506 and the UE 502, the UE 502 may start a registration procedure for mobility and periodic registration update.

In a twenty-third communication 568, the RAN 504 sends the initial UE message to the selected target AMF 518 based on the 5G-GUTI.

In a twenty-fourth communication 570, the target AMF 518 continues with the registration procedure.

In certain embodiments, there may be cases where the initial AMF 506 is not part of the target AMF set, and is not able to get a list of candidate AMFs by querying the NRF 514 with the target AMF set (e.g., the NRF 514 locally pre-configured on the AMF does not provide the requested information, the query to the appropriate NRF provided by the NSSF 512 is not successful, or the initial AMF 506 has knowledge that the initial AMF 506 is not authorized as the serving AMF, and so forth).

Moreover, if the initial AMF 506 requests shared-slice level or slice-specific level NRF about identification information of a network slice isolated target AMF, then the shared-slice level or slice-specific level NRF cannot provide such service.

In some embodiments, the UE 502 may use the current 5G security context to protect the registration request and include the corresponding 5G-GUTI and NG key set identifier (“KSI”) value.

In various embodiments, the UE 502 sends 5G-GUTI of a target AMF for which the UE 502 and the network has no corresponding NAS security context. This new behavior violates the existing UE behavior and no proper triggering aspect for the new UE behavior has been defined leading to uncertain UE behavior.

In certain embodiments, the following features related to registration with AMF reallocation may be used: 1) the NSSF enables NF level slice selection by providing NF level information (e.g., for NRFs or any NFs) to the service consumer NFs, where the NF level may be any such as PLMN level, shared-slice level, or slice-specific level respectively: 2) core network functions (e.g., selected NRF, NSSF, or any NF) informing target AMF about AMF reallocation and SUPI related to an identity request service; and/or 3) initial AMF sending an indication to a UE to enforce the UE to do one or more of the following: a) send a latest 5G-GUTI in registration request but skip applying related NAS security context for registration request protection (e.g., further send only clear text information elements (“IEs”)), and b) send a latest 5G-GUTI in addition to a subscription concealed identifier (“SUCI”) in a registration request (e.g., send further only clear text IEs).

In a first embodiment, there may be an enabling of selection and usage of a core NF with a right NF level to allow registration with AMF reallocation involving isolated network slices. The first embodiment describes the following features to enable right core NF selection and usage to facilitate interaction between an initial AMF and the isolated reallocated AMF to fetch target AMF's 5G-GUTI and to enforce the UE to perform re-registration with a reallocated target AMF using the latest 5G-GUTI even though the latest 5G-GUTI does not point to any corresponding security context.

In some embodiments: 1) the NSSF enables NF level slice selection by providing core NF level information (e.g., for NRFs or any NFs) to the service consumer NFs such as initial AMF, where NF level can indicate any such as PLMN level, shared-slice level, or slice-specific level respectively: 2) core network functions (e.g., NRF) informing target AMF about AMF reallocation and SUPI related to an identity request service triggered by the initial AMF; and/or 3) an initial AMF sending an indication to a UE to enforce the UE to do one or more of the following: a) send a latest 5G-GUTI in a registration request but skip applying a related NAS security context for registration request protection (e.g., further send only clear text IEs), and b) send a latest 5G-GUTI in addition to SUCI in a registration request (e.g., send further only clear text IEs).

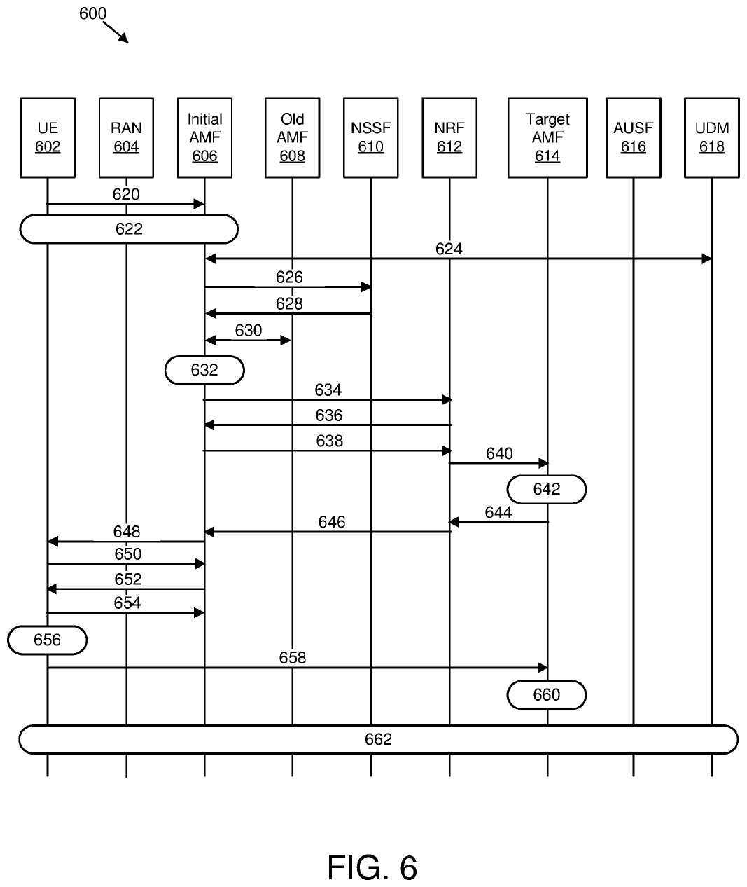

FIG. 6 is a schematic block diagram illustrating one embodiment of a system 600 including communications for registration with indirect AMF reallocation with NRF supporting communications between an initial and a reallocated target AMF. The system 600 includes a UE 602, a RAN 604, an initial AMF 606, an old AMF 608, an NSSF 610, an NRF 612, a target AMF 614, an AUSF 616, and a UDM 618. Each of the communications in the system 600 may include one or more messages.

In a first communication 620, the UE 602 sends a registration request message with SUCI or 5G-GUTI.

In a second communication 622, the initial AMF 606 may perform various general registration communications, such as Namf_communication_UE ContextTransfer and/or response service operations between the initial AMF 606 and source/old AMF 608, identity request and/or response messages between the initial AMF 606 and the UE 602, AUSF selection, primary authentication, NAS security mode command procedure, and the AMF deciding if the registration request needs to be rerouted.

In a third communication 624, if the initial AMF 606 needs UE's subscription information to decide whether to reroute the registration request and UE's slice selection subscription information was not provided by the old AMF 608, the initial AMF 606 selects the UDM 618 and the initial AMF 606 sends to the UDM 618: Nudm_SDM_Get (e.g., SUPI, Slice Selection Subscription data). Further, the UDM 618 responds to the initial AMF 606: response to Nudm_SDM_Get. The initial AMF 606 gets the slice selection subscription data including subscribed single NSSAIs (“S-NSSAIs”).

In a fourth communication 626 (e.g., conditional), if there is a need for slice selection (e.g., the initial AMF 606 cannot serve all the S-NSSAIs from the requested NSSAI permitted by the subscription information), the initial AMF 606 invokes the Nnssf_NSSelection_Get service operation from the NSSF 610 by including requested NSSAI, optional mapping of requested NSSAI, subscribed S-NSSAIs with the default S-NSSAI indication, (e.g., network slice simultaneous registration group (“NSSRG”) information), allowed NSSAI for the other access type (e.g., if any), mapping of allowed NSSAI, PLMN ID of the SUPI, and the tracking area identity (“TAI”) of the UE. The fourth communication 626 may also include an NRF and/or NF level information required indication.

In a fifth communication 628 (e.g., conditional), there is a response to Nnssf_NSSelection_Get (e.g., AMF set or list of AMF addresses, allowed NSSAI for the first access type, mapping of allowed NSSAI, allowed NSSAI for the second access type, mapping of allowed NSSAI, network slice information (“NSI”) IDs, NRFs, NRFs level information per NRF, list of rejected S-NSSAIs and/or cause values, configured NSSAI for the serving PLMN, and/or mapping of configured NSSAI).

The NSSF 610 performs various steps and the NSSF 610 returns to the initial AMF 606 the allowed NSSAI for the first access type, and other information. The NSSF 610 may return the NRFs to be used to select NFs and/or services within the selected network slice instances and the NSSF 610 may also return the NRF's corresponding NF level information such as if the NRFs belong to PLMN level, shared-slice level, and/or slice-specific level respectively. The NRFs returned by the NSSF 610, if any, belong to any level of NRF according to the deployment decision of the operator. The NF level information may be terms are NF access level information, where NF access level may indicate if a NF belongs to a PLMN level, a shared-slice level, a slice-specific level, and/or any NF access level respectively.

In a sixth communication 630 (e.g., conditional), there may be a Namf_Communication_RegistrationStatusUpdate (e.g., including a failure cause). If another AMF is selected, the initial AMF sends a reject indication to the old AMF telling that the UE registration procedure did not fully complete at the initial AMF. The old AMF continues as if the Namf_Communication_UEContextTransfer had never been received.

The initial AMF 606 may select 632 a NRF from the NRFs provided by the NSSF by considering the NRF's NF level information such as if the NRFs belong to PLMN level, shared-slice level, slice-specific level, or any level respectively. The initial AMF 606 may select a NRF that belongs to PLMN level and/or shared-slice level to facilitate communication with a target AMF belonging to an isolated network slice.

In a seventh communication 634 (e.g., conditional), an Nnrf_NFDiscovery_Request may be communicated (e.g., NF type, AMF set). If the initial AMF 606 does not locally store the target AMF address, and if the initial AMF 606 intends to use direct reroute to target AMF or the reroute via next generation (“NG”) RAN (“NG-RAN”) or core network function message needs to include AMF address, then the initial AMF 606 invokes the Nnrf_NFDiscovery_Request service operation from the NRF to find a proper target AMF which has required NF capabilities to serve the UE 602. The NF type is set to AMF. The AMF set is included in the Nnrf_NFDiscovery_Request.

In an eighth communication 636 (e.g., conditional), a response to Nnrf_NFDiscovery_Request may be communicated (e.g., including a list that may include an AMF pointer, an AMF address, and/or additional selection rules and NF capabilities).

The NRF 612 replies with the list of potential target AMFs. The NRF 612 may also provide the details of the services offered by the candidate AMFs along with the notification end-point for each type of notification service that the selected AMF had registered with the NRF 612, if available. In various embodiments, it provides a list of potential target AMFs and their capabilities, and optionally, additional selection rules. Based on the information about registered NFs and required capabilities, a target AMF is selected by the initial AMF 606. In certain embodiments, the additional selection rules may also include an AMF region ID, AMF region information and/or any target AMF selection information.

In a ninth communication 638, the initial AMF 606, if it receives an AMF pointer, an AMF address, and additional selection rules, may select a target AMF to fetch the corresponding identifier (e.g., 5G-GUTI).

If NRF selection based on NF level is not performed at step 632, then the initial AMF 606 may select an NRF from the NRFs provided by the NSSF 610 by considering the NRF's NF level information such as if the NRFs belong to PLMN level, shared-slice level, and/or slice-specific level respectively. The initial AMF 606 may select a NRF that belongs to PLMN level and/or shared-slice level to facilitate communication with a target AMF belonging to an isolated network slice.

The initial AMF 606 sends an identity request to the selected NRF 612 (e.g., that can be PLMN level or shared slice level) to get 5G-GUTI for the reallocated target AMF, the request can include a target AMF ID, an AMF address, and/or an AMF pointer, SUPI, and an indication (e.g., to indicate indirect AMF reallocation and reroute of registration request).

In some embodiments, if the initial AMF 606 has only AMF set information, the initial AMF 606 sends identity request to the selected NRF (e.g., that can be PLMN level or shared slice level) to get 5G-GUTI for the reallocated target AMF, the request may include a target AMF set ID, selection information (e.g., available in the initial AMF or provided by NSSF), SUPI, and an indication (e.g., to indicate indirect AMF reallocation and reroute of registration request).

In various embodiments, the identity request sent by the initial AMF 606 may be referred to as a UE and/or AMF identity request.

In a tenth communication 640, the NRF 612 sends an identity request to the target AMF 614 based on the target AMF ID, AMF address, and AMF pointer to get 5G-GUTI for the reallocated target AMF. The request may include SUPI and an indication (e.g., to indicate indirect AMF reallocation and reroute of registration request).

In certain embodiments, if the NRF 612 receives target AMF set ID information and selection information, the NRF 612 selects the target AMF 614 based on the received target AMF ID and selection information. Further, the NRF 612 sends the identity request to the target AMF 614 based on a selected target AMF ID, AMF address, and/or AMF pointer to get 5G-GUTI for the reallocated target AMF. The request may include SUPI and an indication (e.g., to indicate indirect AMF reallocation and reroute of registration request).

The target AMF 614, on receiving the identity request with SUPI and an indication (e.g., to indicate indirect AMF reallocation and reroute of registration request), generates 642 a 5G-GUTI for the received SUPI and locally stores that new 5G-GUTI along with received SUPI and the related indication (e.g., to indicate indirect AMF reallocation and reroute of registration request).

In an eleventh communication 644, the target AMF 614 provides an identity response to the NRF 612. The identity response may contain 5G-GUTI and SUPI.

In a twelfth communication 646, the NRF 612 provides the received identity response to the initial AMF 606. The identity response may contain 5G-GUTI and SUPI. In certain embodiments, the identity response sent by the NRF 612 may be referred as a UE and/or AMF identity response.

In a thirteenth communication 648, the initial AMF 606 sends a registration accept message to the UE 602. The message may include a 5G-GUTI that is used for the target AMF 614 and may also include an indication to inform the UE any one or more of the following: 1) if the new 5G-GUTI is used by the UE 602 in any subsequent procedure such as a re-registration request, the UE 602 just need to send the new and/or latest 5G-GUTI, but the UE 602 need not apply any corresponding security context: 2) the UE 602 may need to provide a SUCI in addition to the 5G-GUTI; and/or 3) an AMF reallocation and reroute is happening (e.g., in response where the UE 602 may determine to send only clear text IEs in the re-registration request and/a SUCI is sent in addition to the latest 5G-GUTI.

In a fourteenth communication 650, the UE 602 transmits a response, including a registration complete message, to the initial AMF 606.

In a fifteenth communication 652, the initial AMF 606 sends a de-registration request message to the UE 602 with a registration indication to start a new registration procedure and may also include an indication (e.g., re-routing indication) to inform the UE 602 of any one or more of the following: 1) if the new and/or latest 5G-GUTI is used by the UE 602 in any subsequent procedure such as a re-registration request, the UE 602 may send the new and/or latest 5G-GUTI, but the UE 602 need not apply any corresponding security context: 2) the UE may provide a SUCI in addition to the 5G-GUTI; and/or 3) an AMF reallocation and reroute is happening (e.g., in response to the UE 602 determining to send only clear text IEs in the re-registration request and/a SUCI is sent in addition to the latest 5G-GUTI).

In a sixteenth communication 654, the UE 602 sends a de-registration accept message to the initial AMF 606. Afterwards, the UE 602 and the initial AMF 606 releases the NI NAS signaling connection.

Based on an indication (e.g., re-routing indication) received from the network in, the UE 602 may perform 656 one or more of the following: 1) send new and/or latest 5G-GUTI in a re-registration request, but not apply any corresponding security context related to the 5G-GUTI; 2) the UE 602 provides a SUCI in addition to the 5G-GUTI; and/or 3) the UE 602 may determine to send only clear text IEs in the re-registration request and/or a SUCI is sent in addition to the latest 5G-GUTI.

In a seventeenth communication 658, the UE 602 sends an initial UE message to the RAN using the new 5G-GUTI received with an additional SUCI to enable authentication with the target AMF 614. After release the NI NAS signaling connection between the initial AMF 606 and the UE 602, the UE 602 may start a registration procedure for mobility and periodic registration update (e.g., a re-registration procedure). The RAN sends the initial UE message to the selected target AMF based on the 5G-GUTI.

The target AMF 614, on receiving 5G-GUTI, fetches 660 the corresponding locally stored SUPI along with indication on indirect AMF reallocation and reroute of registration request. Even if the 5G-GUTI has no related security context stored in the AMF, the AMF in response to the stored indication, determines to accept the clear text IEs and initiate primary authentication based on SUCI received from the UE 602.

In an eighteenth communication 662, the target AMF 614 continues with the registration procedure.

A second embodiment may enable core NFs to co-ordinate and fetch an identifier from a reallocated AMF to allow registration with AMF reallocation involving isolated network slices. The second embodiment describes the following to enable a core NF belonging to a NF level (e.g., of lower access level such as slice specific NF and/or NRF) to co-ordinate with another core NF belonging to a different NF level (e.g., of higher access level such as shared slice level, PLMN level NF, and/or NRF) to facilitate interaction between an initial AMF and the isolated reallocated AMF to fetch target AMF's 5G-GUTI. Further, a UE may be enforced to perform re-registration with a reallocated target AMF using the latest 5G-GUTI (e.g., one that points to the target AMF) even though the latest 5G-GUTI does not point to any corresponding security context related to the target AMF.

In various embodiments: 1) the NSSF enables NF level slice selection by providing core NF level information (e.g., for NRFs or any NFs) to the service consumer NFs such as initial AMF—the NF level may indicate any level such as PLMN level, shared-slice level, or slice-specific level: 2) core NFs (e.g., NRF) may inform a target AMF about AMF reallocation and SUPI related to an identity request service triggered by an initial AMF: 3) a core NF (e.g., such as AMF/NRF which belong to low NF level and can interact only with restricted and/or limited NFs or slices) selects another core NF (e.g., such as NRF and/or NSSF which belong to high NF level and can interact with any NFs in the PLMN) to co-ordinate and request an identifier (e.g., such as 5G-GUTI) from the target AMF on behalf of the initial AMF due to network slice isolation and related AMF reallocation; and/or 4) an initial AMF sending an indication to a UE to enforce the UE to do one or more of the following: a) send a latest 5G-GUTI in a registration request but skip applying a related and/or available NAS security context for registration request protection (e.g., further send only clear text IEs), b) send a latest 5G-GUTI in addition to SUCI in a registration request (e.g., send further only clear text IEs), and/or c) the UE can determine to send only clear text IEs in the re-registration request even if 5G-GUTI is provided and/or a SUCI is sent in addition to the latest 5G-GUTI.

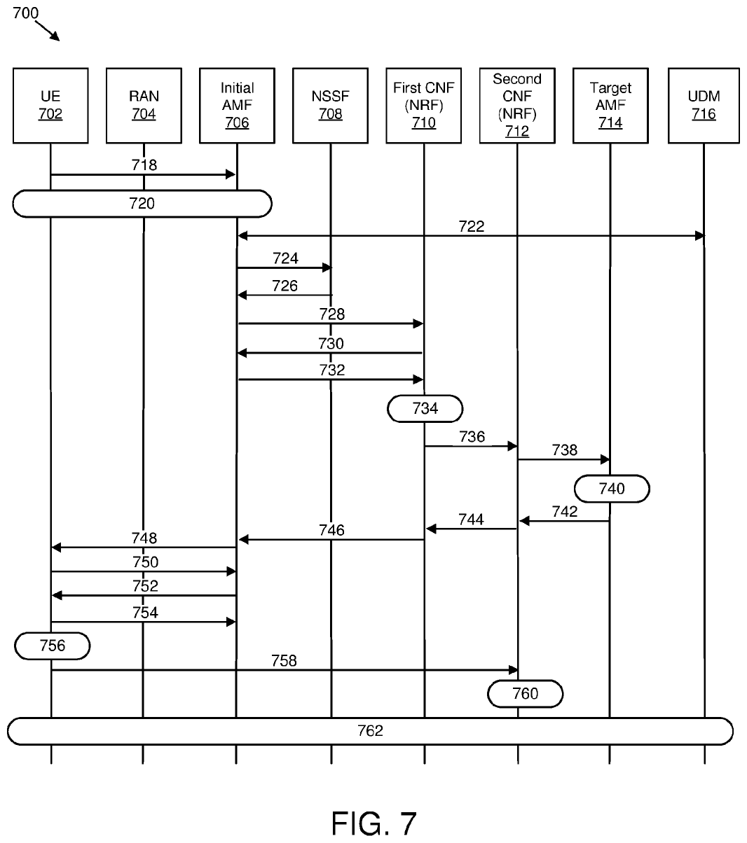

FIG. 7 is a schematic block diagram illustrating one embodiment of a system 700 including communications for registration with indirect AMF reallocation involving co-ordination among NFs with different NF levels. The system 700 includes a UE 702, a RAN 704, an initial AMF 706, an NSSF 708, a first core NF (“CNF”) 710 (e.g., a first NRF), a second CNF 712 (e.g., a second NRF), a target AMF 714, and a UDM 716. Each of the communications in the system 700 may include one or more messages.

In a first communication 718, the UE 702 sends a registration request message with SUCI or 5G-GUTI.

In a second communication 720, the initial AMF 706 may perform various general registration communications, such as Namf_communication_UE ContextTransfer and/or response service operations between the initial AMF 706 and source/old AMF, identity request and/or response messages between the initial AMF 706 and the UE 702, AUSF selection, primary authentication, NAS security mode command procedure, and the AMF deciding if the registration request needs to be rerouted.

In a third communication 722, if the initial AMF 706 needs UE's subscription information to decide whether to reroute the registration request and UE's slice selection subscription information was not provided by the old AMF, the initial AMF 706 selects the UDM 716 and the initial AMF 706 sends to the UDM 716: Nudm_SDM_Get (e.g., SUPI, Slice Selection Subscription data). The initial AMF 706 requests and receives UE's slice selection subscription data from the UDM 716 by invoking the Nudm_SDM_Get service operation.

In a fourth communication 724 (e.g., conditional), if there is a need for slice selection (e.g., the initial AMF 706 cannot serve all the S-NSSAIs from the requested NSSAI permitted by the subscription information), the initial AMF 706 invokes the Nnssf_NSSelection_Get service operation from the NSSF 708 by including requested NSSAI, optional mapping of requested NSSAI, subscribed S-NSSAIs with the default S-NSSAI indication, and other information. The fourth communication 724 may also include an NRF and/or NF level information required indication.

In a fifth communication 726 (e.g., conditional), there is a response to Nnssf_NSSelection_Get (e.g., AMF set or list of AMF addresses, allowed NSSAI for the first access type, mapping of allowed NSSAI, allowed NSSAI for the second access type, mapping of allowed NSSAI, NSI IDs, NRFs, NRFs level information per NRF, and other information). The NSSF may return the NRFs to be used to select NFs and/or services within the selected network slice instances and the NSSF can also return the NRF's corresponding NF level information such as if the NRFs belong to a PLMN level, a shared-slice level, a slice-specific level, and/or any NF access level. The NRFs returned by the NSSF, if any, belong to any level of NRF according to the deployment decision of the operator.

In a sixth communication 728 (e.g., conditional), there may be a Namf_Communication_RegistrationStatusUpdate (e.g., including a failure cause). If another AMF is selected, the initial AMF sends a reject indication to the old AMF telling that the UE registration procedure did not fully complete at the initial AMF.

The initial AMF 706 may select a NRF from the NRFs provided by the NSSF by considering the NRF's NF level information such as if the NRFs belong to PLMN level, shared-slice level, slice-specific level, or any level respectively. The initial AMF 706 may select a NRF that belongs to PLMN level and/or shared-slice level to facilitate communication with a target AMF belonging to an isolated network slice.

If the initial AMF 706 does not receive any NRFs with higher NF level such as PLMN level or shared slice level (e.g., if the initial AMF receives only NRFs with lower NF level such as slice specific level) or if the initial AMF doesn't receive any NF level information for the NRF, then if the initial AMF does not locally store the target AMF address, and if the initial AMF 706 intends to use direct reroute to target AMF or the reroute via NG-RAN or core network function message needs to include AMF address, then the initial AMF 706 invokes the Nnrf_NFDiscovery_Request service operation from the NRF to find a proper target AMF which has required NF capabilities to serve the UE 702. The NF type is set to AMF. The AMF set is included in the Nnrf_NFDiscovery_Request.

In a seventh communication 730 (e.g., conditional), a response to Nnrf_NFDiscovery_Request may be communicated (e.g., including a list that may include an AMF pointer, an AMF address, and/or additional selection rules and NF capabilities).

The first CNF 710 replies with the list of potential target AMFs. The first CNF 710 may also provide the details of the services offered by the candidate AMFs along with the notification end-point for each type of notification service that the selected AMF had registered with the first CNF 710, if available. In various embodiments, it provides a list of potential target AMFs and their capabilities, and optionally, additional selection rules. Based on the information about registered NFs and required capabilities, a target AMF is selected by the initial AMF 706. In certain embodiments, the additional selection rules may also include an AMF region ID, AMF region information and/or any target AMF selection information.

If the initial AMF 706 is not part of the target AMF set, and is not able to get a list of candidate AMFs by querying the NRF with the target AMF set (e.g., the NRF locally pre-configured on AMF does not provide the requested information, the query to the appropriate NRF provided by the NSSF is not successful, or the initial AMF has knowledge that the initial AMF is not authorized as serving AMF, and so forth) then the initial AMF performs step 732 (e.g., sends request to PLMN level or shared slice level NF) via NRF returned by the NSSF 708.

In an eighth communication 732, the initial AMF 706, if it receives an AMF pointer, an AMF address, and additional selection rules, may select a target AMF to fetch the corresponding identifier (e.g., 5G-GUTI).

If NRF selection based on NF level is not performed, then the initial AMF 706 can send an identity request to any NRF (e.g., the first CNF 710, the second CNF 712) from the NRFs provided by the NSSF 708. The initial AMF 706 sends an identity request to the NRF to get 5G-GUTI from the reallocated target AMF for the UE 702. The request may include a target AMF ID, an AMF address, an AMF pointer, SUPI, and/or an indication (e.g., to indicate indirect AMF reallocation and reroute of registration request).

In some embodiments, if the initial AMF 706 has only AMF set information, the initial AMF 706 sends identity request to the selected NRF (e.g., that can be PLMN level or shared slice level) to get 5G-GUTI for the reallocated target AMF, the request may include a target AMF set ID, selection information (e.g., available in the initial AMF or provided by NSSF), SUPI, and an indication (e.g., to indicate indirect AMF reallocation and reroute of registration request).

In various embodiments, the identity request sent by the initial AMF 706 may be referred to as a UE and/or AMF identity request.

The first CNF 710, if it cannot communicate with the target AMF 714 due to network slice isolation, selects 734 another NRF (e.g., can be another core network function also such as NSSF or any NF, the second CNF 712) that belongs to a higher NF level such as PLMN level and/or shared slice level to enable message exchange with the reallocated AMF via the higher-level NF.

In a ninth communication 736 case 1, the first CNF 710 cannot communicate with the target AMF 714. The first CNF 710, if it cannot communicate with the target AMF 714 indicated by the initial AMF 706 due to network slice isolation (e.g., the first CNF 710 belongs to slice specific level), then the first CNF 710 sends an identity request to any other NRF and/or NF that belongs to PLMN level or shared slice level or can access all NFs in the PLMN (e.g., the first CNF 712), the request can include a target AMF ID, an AMF address, an AMF pointer, selection rules information, a SUPI, and/or an indication (e.g., to indicate indirect AMF reallocation and reroute of registration request).

In certain embodiments, if the first CNF 710 receives target AMF set ID information and selection rules information, and if the first CNF 710 can select the target AMF 714, the first CNF 710 performs target AMF selection based on the received target AMF ID and selection information. The first CNF 710, if it cannot communicate with the target AMF 714 indicated by the initial AMF due to network slice isolation (e.g., the first CNF 710 belongs to slice specific level), then the first CNF 710 sends an identity request to any other NRF and/or NF that belongs to PLMN level or shared slice level or can access all NFs in the PLMN (e.g., the second CNF 712), the request can include a target AMF ID, an AMF address, an AMF pointer, s SUPI, and/or an indication (e.g., to indicate indirect AMF reallocation and reroute of registration request).

In some embodiments, if the first CNF 710 receives target AMF set ID information and selection rules information, and if the first CNF 710 cannot select the target AMF 714 and if the first CNF 710 cannot communicate with the target AMF 714 indicated by the initial AMF 706 due to network slice isolation (e.g., the first CNF 710 belongs to slice specific level), then the first CNF 710 sends an identity request to any other NRF and/or NF that belongs to PLMN level or shared slice level or can access all NFs in the PLMN (e.g., the second CNF 712), the request can include an AMF set ID, selection rules information, a SUPI, and/or an indication (e.g., to indicate indirect AMF reallocation and reroute of registration request).

In a ninth communication 736 case 2, first CNF 710 can communicate with the target AMF 714 and step 738 can be skipped.

In one embodiment, the first CNF 710, if it can communicate with the target AMF 714 indicated by the initial AMF 706, then the first CNF 710 sends an identity request to the target AMF 714 based on a target AMF ID, an AMF address, and/or an AMF pointer to get 5G-GUTI from the reallocated target AMF 714. The request can include SUPI and an indication (e.g., to indicate indirect AMF reallocation and reroute of registration request).

In some embodiments, if the first CNF 710 receives target AMF set ID information and selection rules information, the first CNF 710 selects the target AMF 714 based on the received target AMF ID and selection rules information. Further, the first CNF 710, if it can communicate with the target AMF 714 indicated by the initial AMF, sends an identity request to the target AMF 714 based on a selected target AMF ID, an AMF address, and/or an AMF pointer to get 5G-GUTI from the reallocated target AMF. The request can include SUPI and an indication (e.g., to indicate indirect AMF reallocation and reroute of registration request).

In a tenth communication 738, the second CNF 712, which belongs to higher NF level, sends the identity request to the target AMF 714. The request can include SUPI and an indication (e.g., to indicate indirect AMF reallocation and reroute of registration request).

In various embodiments, the second CNF 712, which belongs to higher NF level, if receives target AMF set information and selection rule information, the second CNF 712 performs target AMF selection and sends an identity request to the target AMF 714. The request may include SUPI and an indication (e.g., to indicate indirect AMF reallocation and reroute of registration request). In certain embodiments, the second CNF 712 may be an NSSF.

The target AMF 714, on receiving the identity request with SUPI and the indication (e.g., to indicate indirect AMF reallocation and reroute of registration request), generates 740 a 5G-GUTI for the received SUPI and locally stores that new 5G-GUTI along with received SUPI and the related indication (e.g., to indicate indirect AMF reallocation and reroute of registration request).

In an eleventh communication 742, the target AMF 714 provides the identity response to the second CNF 712 (e.g., belonging to high NF level) which requested the identity. The identity response may contain 5G-GUTI and SUPI.

In a twelfth communication 744, the second CNF 712 provides the received identity response to the first CNF 710 (e.g., belonging to low NF level). The identity response may contain 5G-GUTI and SUPI.

In a thirteenth communication 746, the first CNF 710 provides the received identity response to the initial AMF 706. The identity response may contain 5G-GUTI and SUPI.

In certain embodiments, the identity response sent by the first CNF 710 may be referred to as a UE and/or AMF identity response.

In a fourteenth communication 748, the initial AMF 706 sends a registration accept message to the UE 702. The message may include a 5G-GUTI that is used for the target AMF 714 and may also include an indication to inform the UE any one or more of the following: 1) if the new 5G-GUTI is used by the UE 702 in any subsequent procedure such as a re-registration request, the UE 702 just need to send the new and/or latest 5G-GUTI, but the UE 702 need not apply any corresponding security context: 2) the UE 702 may need to provide a SUCI in addition to the 5G-GUTI; and/or 3) an AMF reallocation and reroute is happening (e.g., in response where the UE 702 may determine to send only clear text IEs in the re-registration request and/a SUCI is sent in addition to the latest 5G-GUTI.

In a fifteenth communication 750, the UE 702 transmits a response, including a registration complete message, to the initial AMF 706.

In a sixteenth communication 752, the initial AMF 706 sends a de-registration request message to the UE 702 with a registration indication to start a new registration procedure and may also include an indication (e.g., re-routing indication) to inform the UE 702 of any one or more of the following: 1) if the new and/or latest 5G-GUTI is used by the UE 702 in any subsequent procedure such as a re-registration request, the UE 702 may send the new and/or latest 5G-GUTI, but the UE 702 need not apply any corresponding security context: 2) the UE 702 may provide a SUCI in addition to the 5G-GUTI; and/or 3) an AMF reallocation and reroute is happening (e.g., in response to the UE 702 determining to send only clear text IEs in the re-registration request and/a SUCI is sent in addition to the latest 5G-GUTI).

In a seventeenth communication 754, the UE 702 sends a de-registration accept message to the initial AMF 706. Afterwards, the UE 702 and the initial AMF 706 releases the NI NAS signaling connection.

Based on an indication (e.g., re-routing indication) received from the network, the UE 702 may perform 756 one or more of the following: 1) send new and/or latest 5G-GUTI in a re-registration request, but not apply any corresponding security context related to the 5G-GUTI; 2) the UE 702 provides a SUCI in addition to the 5G-GUTI; and/or 3) the UE 702 may determine to send only clear text IEs in the re-registration request and/or a SUCI is sent in addition to the latest 5G-GUTI.

In an eighteenth communication 758, the UE 702 sends an initial UE message to the RAN using the new 5G-GUTI received with an additional SUCI to enable authentication with the target AMF 714. After release the NI NAS signaling connection between the initial AMF 706 and the UE 702, the UE 702 may start a registration procedure for mobility and periodic registration update (e.g., a re-registration procedure). The RAN sends the initial UE message to the selected target AMF based on the 5G-GUTI.

The target AMF 714, on receiving 5G-GUTI, fetches 760 the corresponding locally stored SUPI along with indication on indirect AMF reallocation and reroute of registration request. Even if the 5G-GUTI has no related security context stored in the AMF, the AMF in response to the stored indication, determines to accept the clear text IEs and initiate primary authentication based on SUCI received from the UE 702.

In a nineteenth communication 762, the target AMF 714 continues with the registration procedure. In some embodiments, the NF level information may be considered NF access level information. An NF access level can indicate if a NF belong to a PLMN level, a shared-slice level, a slice-specific level, and/or any NF-access level.

A third embodiment may correspond to enabling an NSSF to fetch an identifier from a reallocated AMF to allow registration with AMF reallocation involving isolated network slices. The third embodiment describes features to enable the NSSF or any core NF to facilitate interaction between an initial AMF and an isolated reallocated AMF to fetch reallocated target AMF's 5G-GUTI for the UE and to enforce the UE to perform re-registration with the reallocated target AMF using the latest 5G-GUTI.

In various embodiments: 1) the NSSF enables NF level slice selection by providing core NF level information (e.g., for NRFs or any NFs) to the service consumer NFs such as an initial AMF—where the NF level may indicate any level such as a PLMN level, a shared-slice level, and/or a slice-specific level: 2) the initial AMF requests NSSF using a new service operation message to get an identifier for the UE from the reallocated target AMF by providing SUPI and AMF reallocation indication: 3) the NSSF provides a communication service between the initial AMF and reallocated target AMF—the NSSF requests and receives an identifier from the target AMF by providing an AMF reallocation indication and a SUPI related to an identity request service triggered by the initial AMF; and/or 4) the initial AMF sends an indication to the UE to enforce the UE to do one or more of the following: a) send a latest 5G-GUTI in a registration request but skip applying a related NAS security context for registration request protection (e.g., further send only clear text IEs), and/or b) send a latest 5G-GUTI in addition to the SUCI in a registration request (e.g., send further only clear text IEs).

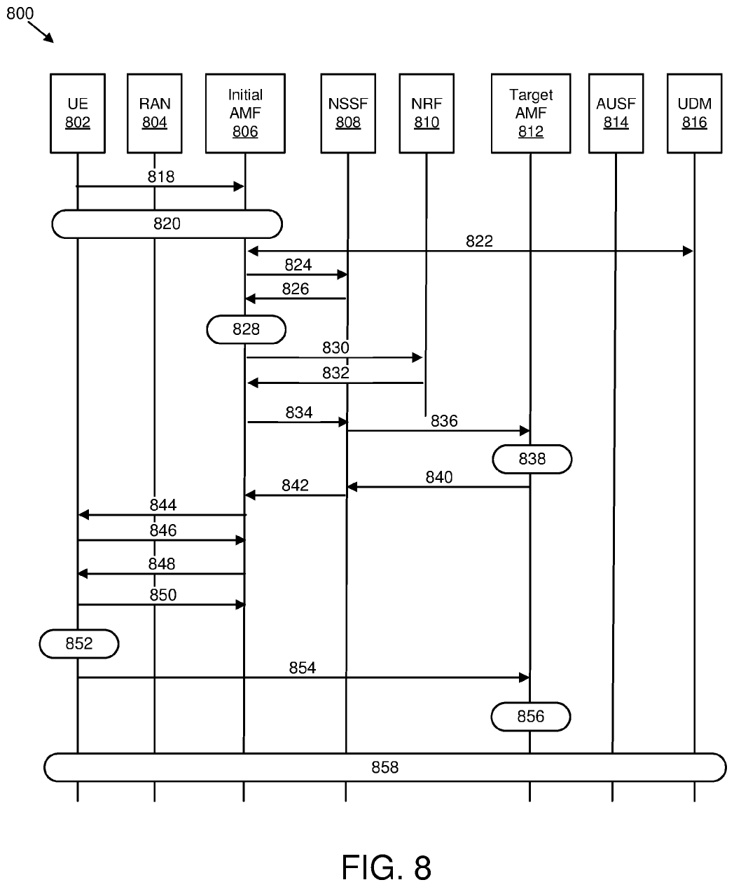

FIG. 8 is a schematic block diagram illustrating one embodiment of a system 800 including communications for registration with indirect AMF reallocation with an NSSF and/or any core network function supporting communications between an initial and a reallocated target AMF. The system 800 includes a UE 802, a RAN 804, an initial AMF 806, an NSSF 808, a NRF 810, a target AMF 812, an AUSF 814, and a UDM 816. Each of the communications in the system 800 may include one or more messages.

In a first communication 818, the UE 802 sends a registration request message with SUCI or 5G-GUTI.

In a second communication 820, the initial AMF 806 may perform various general registration communications, such as Namf_communication_UE ContextTransfer and/or response service operations between the initial AMF 806 and source/old AMF, identity request and/or response messages between the initial AMF 806 and the UE 802, AUSF selection, primary authentication, NAS security mode command procedure, and the AMF deciding if the registration request needs to be rerouted.

In a third communication 822, if the initial AMF 806 needs UE's subscription information to decide whether to reroute the registration request and UE's slice selection subscription information was not provided by the old AMF, the initial AMF 806 selects the UDM 816 and the initial AMF 806 sends to the UDM 816: Nudm_SDM_Get (e.g., SUPI, Slice Selection Subscription data). The initial AMF 806 requests and receives UE's slice selection subscription data from the UDM 816 by invoking the Nudm_SDM_Get service operation.

In a fourth communication 824 (e.g., conditional), if there is a need for slice selection (e.g., the initial AMF 806 cannot serve all the S-NSSAIs from the requested NSSAI permitted by the subscription information), the initial AMF 806 invokes the Nnssf_NSSelection_Get service operation from the NSSF 808 by including requested NSSAI, optional mapping of requested NSSAI, subscribed S-NSSAIs with the default S-NSSAI indication, and other information. The fourth communication 824 may also include an NRF and/or NF level information required indication.

In a fifth communication 826 (e.g., conditional), there is a response to Nnssf_NSSelection_Get (e.g., AMF set or list of AMF addresses, allowed NSSAI for the first access type, mapping of allowed NSSAI, allowed NSSAI for the second access type, mapping of allowed NSSAI, NSI IDs, NRFs, NRFs level information per NRF, and other information). The NSSF may return the NRFs to be used to select NFs and/or services within the selected network slice instances and the NSSF can also return the NRF's corresponding NF level information such as if the NRFs belong to a PLMN level, a shared-slice level, a slice-specific level, and/or any NF access level. The NRFs returned by the NSSF, if any, belong to any level of NRF according to the deployment decision of the operator.

The initial AMF 806 may select 828 a NRF from the NRFs provided by the NSSF by considering the NRF's NF level information such as if the NRFs belong to PLMN level, shared-slice level, slice-specific level, or any level respectively. The initial AMF 806 may select a NRF that belongs to PLMN level and/or shared-slice level to facilitate communication with a target AMF belonging to an isolated network slice. If the initial AMF 806 finds an NRF with PLMN level or shared slice level, then further steps can be adopted with NRF as the common core network function to get target AMF information and to interact with the reallocated target AMF if required. If the initial AMF 806 cannot find any NRF with PLMN level or shared slice level or if the initial AMF didn't receive any NRF and/or NF level information from the NSSF, then step 828 can be skipped.

In a sixth communication 830 (e.g., conditional), there may be a Namf_Communication_RegistrationStatusUpdate (e.g., including a failure cause). If another AMF is selected, the initial AMF sends a reject indication to the old AMF telling that the UE registration procedure did not fully complete at the initial AMF.

In the sixth communication 830, if the initial AMF 806 does not receive any NRFs with higher NF level such as PLMN level or shared slice level (e.g., if the initial AMF receives only NRFs with lower NF level such as slice specific level) or if the initial AMF 806 doesn't receive any NF level information for the NRF, then if the initial AMF 806 does not locally store the target AMF address, and if the initial AMF intends to use direct reroute to the target AMF 812 or the reroute via NG-RAN message needs to include AMF address, then the initial AMF 806 invokes the Nnrf_NFDiscovery_Request service operation from the NRF to find a proper target AMF which has required NF capabilities to serve the UE 802. The NF type is set to AMF. The AMF set is included in the Nnrf_NFDiscovery_Request.

If the initial AMF 806 does not locally store the target AMF address, and if the initial AMF 806 intends to use direct reroute to the target AMF 812 or the reroute via NG-RAN or core network function message needs to include AMF address, then the initial AMF 806 invokes the Nnrf_NFDiscovery_Request service operation from the NRF to find a proper target AMF which has required NF capabilities to serve the UE 806. The NF type is set to AMF. The AMF set is included in the Nnrf_NFDiscovery_Request.

In a seventh communication 832 (e.g., conditional), a response to Nnrf_NFDiscovery_Request may be communicated (e.g., including a list that may include an AMF pointer, an AMF address, and/or additional selection rules and NF capabilities).

The NRF 810 replies with the list of potential target AMFs. The NRF 810 may also provide the details of the services offered by the candidate AMFs along with the notification end-point for each type of notification service that the selected AMF had registered with the NRF, if available. In some embodiments, it provides a list of potential target AMFs and their capabilities, and optionally, additional selection rules. Based on the information about registered NFs and required capabilities, a target AMF may be selected by the initial AMF. In various embodiments, the additional selection rules can also include AMF region ID or AMF region information.

In an eighth communication 834, the initial AMF 806, if it receives an AMF pointer, an AMF address, and/or additional selection rules, may select a target AMF to fetch the corresponding identifier (e.g., such as 5G-GUTI). The initial AMF 806 sends an identity request to the NSSF 808 to get 5G-GUTI for the reallocated target AMF. The request may include a target AMF ID, an AMF address, an AMF pointer, a SUPI, and/or an indication (e.g., to indicate indirect AMF reallocation and reroute of registration request).

In certain embodiments, if the initial AMF 806 has only AMF set information, the initial AMF 806 sends an identity request to the NSSF 808 to get 5G-GUTI for the reallocated target AMF. The request may include a target AMF set ID, selection information (e.g., available in the initial AMF 806 or provided by the NSSF 808), a SUPI, and/or an indication (e.g., to indicate indirect AMF reallocation and reroute of registration request).

In some embodiments, the identity request sent by the initial AMF 806 can be referred as a UE and/or AMF identity request.

In a ninth communication 836, the NSSF 808 sends the identity request to the target AMF 812 based on the target AMF ID, the AMF address and/or the AMF pointer to get 5G-GUTI for the reallocated target AMF. The request may include the SUPI and/or the indication (e.g., to indicate indirect AMF reallocation and reroute of registration request).

In various embodiments, if the NSSF 808 receives target AMF set ID information and selection information, the NSSF 808 selects the target AMF 812 based on the received target AMF set ID and selection information either by itself or by querying a suitable NRF to get the target AMF address and pointer information (e.g., PLMN level NRF or a shared slice NRF may be used). Further, the NSSF 808 sends the identity request to the target AMF 812 based on the selected target AMF ID, the AMF address, and/or the AMF pointer to get 5G-GUTI for the reallocated target AMF. The request may include the SUPI and/or the indication (e.g., to indicate indirect AMF reallocation and reroute of registration request).

The target AMF 812, on receiving the identity request with the SUPI and the indication (e.g., to indicate indirect AMF reallocation and reroute of registration request), generates 838 a 5G-GUTI for the received SUPI and locally stores that new 5G-GUTI along with received SUPI and the related indication (e.g., to indicate indirect AMF reallocation and reroute of registration request).

In a tenth communication 840, the target AMF 812 provides an identity response to the NSSF 808. The identity response may contain 5G-GUTI and SUPI.

In an eleventh communication 842, the NSSF 808 provides the received identity response to the initial AMF 806. The identity response may contain 5G-GUTI and SUPI.

In certain embodiments, the identity response sent by the NSSF 808 may be referred to as a UE and/or AMF identity response.

In a twelfth communication 844, the initial AMF 806 sends a registration accept message to the UE 802. The message may include a 5G-GUTI that is used for the target AMF 812 and may also include an indication to inform the UE any one or more of the following: 1) if the new 5G-GUTI is used by the UE 802 in any subsequent procedure such as a re-registration request, the UE 802 just need to send the new and/or latest 5G-GUTI, but the UE 802 need not apply any corresponding security context: 2) the UE 802 may need to provide a SUCI in addition to the 5G-GUTI; and/or 3) an AMF reallocation and reroute is happening (e.g., in response where the UE 802 may determine to send only clear text IEs in the re-registration request and/a SUCI is sent in addition to the latest 5G-GUTI.

In a thirteenth communication 846, the UE 802 transmits a response, including a registration complete message, to the initial AMF 806.

In a fourteenth communication 848, the initial AMF 806 sends a de-registration request message to the UE 802 with a registration indication to start a new registration procedure and may also include an indication (e.g., re-routing indication) to inform the UE 802 of any one or more of the following: 1) if the new and/or latest 5G-GUTI is used by the UE 802 in any subsequent procedure such as a re-registration request, the UE 802 may send the new and/or latest 5G-GUTI, but the UE 802 need not apply any corresponding security context: 2) the UE 802 may provide a SUCI in addition to the 5G-GUTI; and/or 3) an AMF reallocation and reroute is happening (e.g., in response to the UE 802 determining to send only clear text IEs in the re-registration request and/a SUCI is sent in addition to the latest 5G-GUTI).

In a fifteenth communication 850, the UE 802 sends a de-registration accept message to the initial AMF 806. Afterwards, the UE 802 and the initial AMF 806 releases the NI NAS signaling connection.

Based on an indication (e.g., re-routing indication) received from the network, the UE 802 may perform 852 one or more of the following: 1) send new and/or latest 5G-GUTI in a re-registration request, but not apply any corresponding security context related to the 5G-GUTI; 2) the UE 802 provides a SUCI in addition to the 5G-GUTI; and/or 3) the UE 802 may determine to send only clear text IEs in the re-registration request and/or a SUCI is sent in addition to the latest 5G-GUTI.

In a sixteenth communication 854, the UE 802 sends an initial UE message to the RAN using the new 5G-GUTI received with an additional SUCI to enable authentication with the target AMF 812. After release the NI NAS signaling connection between the initial AMF 806 and the UE 802, the UE 802 may start a registration procedure for mobility and periodic registration update (e.g., a re-registration procedure). The RAN sends the initial UE message to the selected target AMF based on the 5G-GUTI.

The target AMF 812, on receiving 5G-GUTI, fetches 856 the corresponding locally stored SUPI along with indication on indirect AMF reallocation and reroute of registration request. Even if the 5G-GUTI has no related security context stored in the AMF, the AMF in response to the stored indication, determines to accept the clear text IEs and initiate primary authentication based on SUCI received from the UE 802.

In a seventeenth communication 858, the target AMF 812 continues with the registration procedure. In some embodiments, the NF level information may be considered NF access level information. An NF access level can indicate if a NF belong to a PLMN level, a shared-slice level, a slice-specific level, and/or any NF-access level.

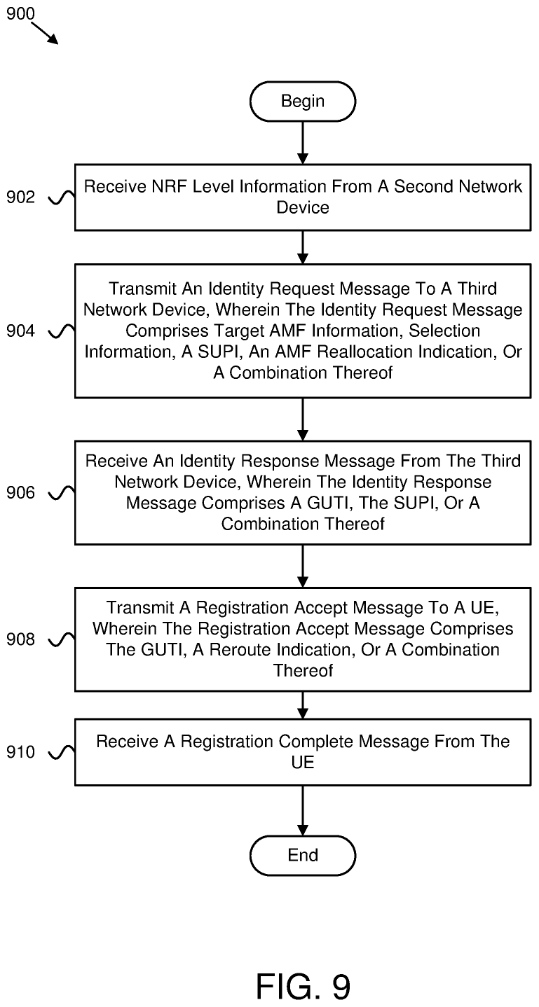

FIG. 9 is a flow chart diagram illustrating one embodiment of a method 900 for communicating identity messages between network devices. In some embodiments, the method 900 is performed by an apparatus, such as the network unit 104. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a first network device, NRF level information from a second network device. In some embodiments, the method 900 includes transmitting 904 an identity request message to a third network device, wherein the identity request message comprises target AMF information, selection information, a SUPI, an AMF reallocation indication, or a combination thereof. In certain embodiments, the method 900 includes receiving 906 an identity response message from the third network device, wherein the identity response message includes a GUTI, the SUPI, or a combination thereof. In various embodiments, the method 900 includes transmitting 908 a registration accept message to a UE, wherein the registration accept message includes the GUTI, a reroute indication, or a combination thereof. In some embodiments, the method 900 includes receiving 910 a registration complete message from the UE.

In certain embodiments, the first network device comprises an initial AMF. In some embodiments, the second network device comprises a NSSF. In various embodiments, the third network device comprises a NRF, a CNF, or a combination thereof.

In one embodiment, the method 900 further comprises selecting an NRF based on the NRF level information. In certain embodiments, the method 900 further comprises transmitting a deregistration request message to the UE, wherein the deregistration request message comprises the reroute indication. In some embodiments, the method 900 further comprises receiving a deregistration response message from the UE.

In various embodiments, the deregistration request message comprises a NAS message transmitted to the UE. In one embodiment, the third network device selects another network device based on the identity request message. In certain embodiments, the NRF level information indicates whether the NRF belongs to a PLMN level, a shared-slice level, or a slice-specific level.

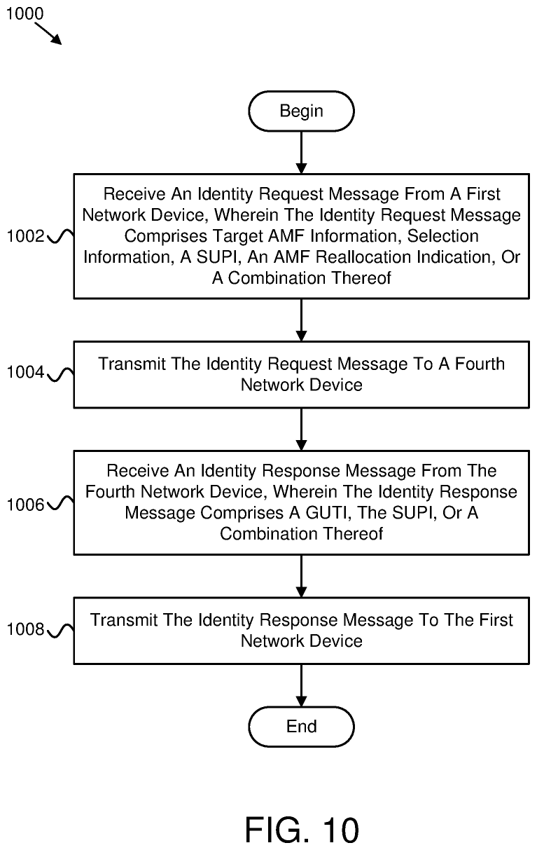

FIG. 10 is a flow chart diagram illustrating another embodiment of a method 1000 for communicating identity messages between network devices. In some embodiments, the method 1000 is performed by an apparatus, such as the network unit 104. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002, at a third network device, an identity request message from a first network device, wherein the identity request message comprises target AMF information, selection information, a SUPI, an AMF reallocation indication, or a combination thereof. In some embodiments, the method 1000 includes transmitting 1004 the identity request message to a fourth network device. In certain embodiments, the method 1000 includes receiving 1006 an identity response message from the fourth network device, wherein the identity response message includes a GUTI, the SUPI, or a combination thereof. In various embodiments, the method 1000 includes transmitting 1008 the identity response message to the first network device.

In certain embodiments, the first network device comprises an initial AMF. In some embodiments, the third network device comprises a NRF, a CNF, or a combination thereof.

In various embodiments, the fourth network device comprises a target AMF. In one embodiment, the method 1000 further comprises selecting another network device based on the identity request message.

In one embodiment, an apparatus comprises a first network device, the apparatus further comprising: a processor; and a memory coupled to the processor, the processor configured to cause the apparatus to: receive NRF level information from a second network device: transmit an identity request message to a third network device, wherein the identity request message comprises target AMF information, selection information, a SUPI, an AMF reallocation indication, or a combination thereof: receive an identity response message from the third network device, wherein the identity response message comprises a GUTI, the SUPI, or a combination thereof; transmit a registration accept message to a UE, wherein the registration accept message comprises the GUTI, a reroute indication, or a combination thereof; and receive a registration complete message from the UE.

In certain embodiments, the first network device comprises an initial AMF.

In some embodiments, the second network device comprises a NSSF.

In various embodiments, the third network device comprises a NRF, a CNF, or a combination thereof.

In one embodiment, the processor is configured to cause the apparatus to select an NRF based on the NRF level information.

In certain embodiments, the processor is configured to cause the apparatus to transmit a deregistration request message to the UE, wherein the deregistration request message comprises the reroute indication.

In some embodiments, the processor is configured to cause the apparatus to receive a deregistration response message from the UE.

In various embodiments, the deregistration request message comprises a NAS message transmitted to the UE.

In one embodiment, the third network device selects another network device based on the identity request message.

In certain embodiments, the NRF level information indicates whether the NRF belongs to a PLMN level, a shared-slice level, or a slice-specific level.

In one embodiment, a method of a first network device, the method comprises: receiving NRF level information from a second network device: transmitting an identity request message to a third network device, wherein the identity request message comprises target AMF information, selection information, a SUPI, an AMF reallocation indication, or a combination thereof: receiving an identity response message from the third network device, wherein the identity response message comprises a GUTI, the SUPI, or a combination thereof: transmitting a registration accept message to a UE, wherein the registration accept message comprises the GUTI, a reroute indication, or a combination thereof; and receiving a registration complete message from the UE.

In certain embodiments, the first network device comprises an initial AMF.

In some embodiments, the second network device comprises a NSSF.

In various embodiments, the third network device comprises a NRF, a CNF, or a combination thereof.

In one embodiment, the method further comprises selecting an NRF based on the NRF level information.

In certain embodiments, the method further comprises transmitting a deregistration request message to the UE, wherein the deregistration request message comprises the reroute indication.

In some embodiments, the method further comprises receiving a deregistration response message from the UE.

In various embodiments, the deregistration request message comprises a NAS message transmitted to the UE.

In one embodiment, the third network device selects another network device based on the identity request message.

In certain embodiments, the NRF level information indicates whether the NRF belongs to a PLMN level, a shared-slice level, or a slice-specific level.

In one embodiment, an apparatus comprises a third network device, the apparatus further comprising: a processor; and a memory coupled to the processor, the processor configured to cause the apparatus to: receive an identity request message from a first network device, wherein the identity request message comprises target AMF information, selection information, a SUPI, an AMF reallocation indication, or a combination thereof: transmit the identity request message to a fourth network device: receive an identity response message from the fourth network device, wherein the identity response message comprises a GUTI, the SUPI, or a combination thereof; and transmit the identity response message to the first network device.

In certain embodiments, the first network device comprises an initial AMF.

In some embodiments, the third network device comprises a NRF, a CNF, or a combination thereof.

In various embodiments, the fourth network device comprises a target AMF.

In one embodiment, the processor is configured to cause the apparatus to select another network device based on the identity request message.

In one embodiment, a method of a third network device, the method comprises: receiving an identity request message from a first network device, wherein the identity request message comprises target AMF information, selection information, a SUPI, an AMF reallocation indication, or a combination thereof: transmitting the identity request message to a fourth network device: receiving an identity response message from the fourth network device, wherein the identity response message comprises a GUTI, the SUPI, or a combination thereof; and transmitting the identity response message to the first network device.

In certain embodiments, the first network device comprises an initial AMF.

In some embodiments, the third network device comprises a NRF, a CNF, or a combination thereof.

In various embodiments, the fourth network device comprises a target AMF.

In one embodiment, the method further comprises selecting another network device based on the identity request message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A first network device, comprising:
at least one memory; and
at least one processor coupled with the at least one memory and configured to cause the first network device to:
receive network repository function (NRF) level information from a second network device;
transmit an identity request message to a third network device, wherein the identity request message comprises target access and mobility management function (AMF) information, selection information, a subscription permanent identifier (SUPI), an AMF reallocation indication, or a combination thereof;
receive an identity response message from the third network device, wherein the identity response message comprises a global unique temporary identifier (GUTI), the SUPI, or a combination thereof;
transmit a registration accept message to a user equipment (UE), wherein the registration accept message comprises the GUTI, a reroute indication, or a combination thereof; and
receive a registration complete message from the UE.

2. The first network device of claim 1, wherein the first network device comprises an initial AMF.

3. The first network device of claim 1, wherein the second network device comprises a network slice selection function (NSSF).

4. The first network device of claim 1, wherein the third network device comprises a NRF, a core network function (CNF), or a combination thereof.

5. The first network device of claim 1, wherein the at least one processor is configured to cause the first network device to select an NRF based on the NRF level information.

6. The first network device of claim 1, wherein the at least one processor is configured to cause the first network device to transmit a deregistration request message to the UE, wherein the deregistration request message comprises the reroute indication.

7. The first network device of claim 6, wherein the at least one processor is configured to cause the first network device to receive a deregistration response message from the UE.

8. The first network device of claim 6, wherein the deregistration request message comprises a non-access stratum (NAS) message transmitted to the UE.

9. The first network device of claim 1, wherein the third network device selects another network device based on the identity request message.

10. The first network device of claim 1, wherein the NRF level information indicates whether the NRF belongs to a public land mobile network (PLMN) level, a shared-slice level, or a slice-specific level.

11. A third network device, comprising:
at least one memory; and
at least one processor coupled with the at least one memory and configured to cause the third network device to:
receive an identity request message from a first network device, wherein the identity request message comprises target access and mobility management function (AMF) information, selection information, a subscription permanent identifier (SUPI), an AMF reallocation indication, or a combination thereof;
transmit the identity request message to a fourth network device;
receive an identity response message from the fourth network device, wherein the identity response message comprises a global unique temporary identifier (GUTI), the SUPI, or a combination thereof; and
transmit the identity response message to the first network device.

12. The third network device of claim 11, wherein the first network device comprises an initial AMF.

13. The third network device of claim 11, wherein the third network device comprises a NRF, a core network function (CNF), or a combination thereof.

14. The third network device of claim 11, wherein the fourth network device comprises a target AMF.

15. The third network device claim 11, wherein the at least one processor is configured to cause the third network device to select another network device based on the identity request message.

16. A method of performing a network function at a first network device, the method comprising:
receiving network repository function (NRF) level information from a second network device;
transmitting an identity request message to a third network device, wherein the identity request message comprises target access and mobility management function (AMF) information, selection information, a subscription permanent identifier (SUPI), an AMF reallocation indication, or a combination thereof;
receiving an identity response message from the third network device, wherein the identity response message comprises a global unique temporary identifier (GUTI), the SUPI, or a combination thereof;
transmitting a registration accept message to a user equipment (UE), wherein the registration accept message comprises the GUTI, a reroute indication, or a combination thereof; and
receiving a registration complete message from the UE.

17. The method of claim 16, wherein the first network device comprises an initial AMF.

18. The method of claim 16, wherein the second network device comprises a network slice selection function (NSSF).

19. A method of performing a third network device, the method comprising:
receiving an identity request message from a first network device, wherein the identity request message comprises target access and mobility management function (AMF) information, selection information, a subscription permanent identifier (SUPI), an AMF reallocation indication, or a combination thereof;
transmitting the identity request message to a fourth network device;
receiving an identity response message from the fourth network device, wherein the identity response message comprises a global unique temporary identifier (GUTI), the SUPI, or a combination thereof; and
transmitting the identity response message to the first network device.

20. The method of claim 19, wherein the first network device comprises an initial AMF.
